(19) United States
(12) Patent Application Publication
(10) Pub. No.: US 2005/0052877 A1
(43) Pub. Date: Mar. 10, 2005

(54) Adjustable lighting apparatus

(76) Inventor: Chao-Jung Wu, Tainan (TW)

Correspondence Address: Cooper & Dunham LLP, 1185 Avenue of the Americas, New York, NY, 10036, US

(21) Appl. No.: 10/657,333

(22) Filed: Sep. 8, 2003

(51) Int. Cl. F21V 21/10

(52) U.S. Cl. 362/429

(57) ABSTRACT

An adjustable lighting apparatus having a flexible arm and a fully rotatable head is disclosed, wherein one end of the flexible arm has a power connector and another end has a terminal fitting. The terminal fitting is attached with a circular socket on the open end for assembling the head. The head has a lighting element installed inside and a plug-in portion at one end. When the head and the flexible arm are joined together, the head can be rotated around for a full circle to adjust the light to a desired position and projection angle without difficulty. This unique design can prevent an awkward situation that the support arm might interfere with the light path and the undesired shifting of the lamp position as a result of the inherent elasticity of the flexible arm.

### BACKGROUND OF THE INVENTION

1. Field of the Invention

The present invention relates to an adjustable lighting apparatus, in particular to a unique design of a lamp that allows the head to be rotated around for a full circle to set the light to any desired position and to project from any angle.

2. Description of Related Arts

For a conventional adjustable lamp, the support arm is often an extension of the lamp, and at the end of the extension arm is the head portion with a light bulb installed therein. The usual way to adjust the light intensity and the angle of projection of the lamp is to manually push or pull the extension arm and the head to the desired position, so that the light from the head portion can be projected to the desired position with a certain angle. The extension arm of the adjustable lamp is usually bendable for adjusting the lamp position, but the flexibility of the extension arm is accompanied by the inherent elasticity of the extension arm, which often causes the extension arm to bounce back slightly after a positional adjustment. This creates inconvenience for a user, as it is not very easy to set the lamp at a certain position with a precise projection angle. The adjustment process may take several repetitive actions, by narrowing the gap each time, after finishing the positional adjustment, in order to set the lamp to the right position with the right projection angle. Furthermore, it is impossible to turn the head of the lamp around for a full circle with a conventional lamp.

### SUMMARY OF THE INVENTION

The main object of the present invention is to provide an adjustable lighting apparatus that allows the head to be rotated around for a full circle to set the light to any position with any projection angle, whereby this unique design is able to prevent the support arm from interfering with the light projection path at a certain angle.

To this end, an adjustable lighting apparatus is provided having a flexible arm and a fully rotatable head as separate units, which need to be assembled to form a an operational unit.

One end of the flexible arm is fixed with a power connector for drawing necessary power from a power outlet, and another end of the flexible arm has a terminal fitting attached with a circular socket.

The head has a plug-in at one end to be fitted against the corresponding terminal fitting, whereby the head of the adjustable lighting apparatus can be rotated around for a full circle to any light position with any projection angle.

The present design, in accordance with the present invention, is able to avoid shifting of the extension arm as a result of bending of the arm of the lighting apparatus.

The present design, in accordance with the present invention, is able to prevent the extension arm from interfering with the light projection path at a certain angle.

The features and structure of the present invention will be more clearly understood when taken in conjunction with the accompanying figures

### BRIEF DESCRIPTION OF THE DRAWINGS

FIG. 1 is a perspective view of the present invention.

FIG. 2 is a cross-section of the assembly of the adjustable lighting apparatus.

FIG. 3 is one embodiment of the lighting apparatus with the head set up in one position.

FIG. 4 is the same embodiment with the head rotated to a second position.

### DETAILED DESCRIPTION OF THE PREFERRED EMBODIMENT

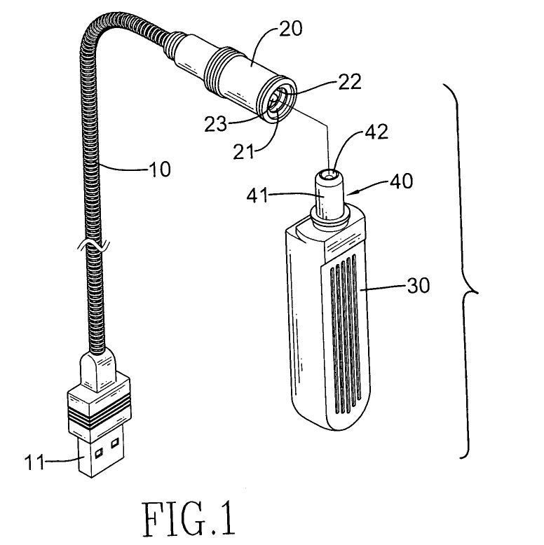

The adjustable lighting apparatus, as shown in FIG. 1, has a head that can be rotated around for a full circle, wherein the construct of the adjustable lighting apparatus (1) includes a flexible arm (10) with a terminal fitting (20), and a head (30). One end of the flexible arm (10) is fitted with a power connector (11) for drawing the necessary operating power from a power output. Another end of the flexible arm (10) has the terminal fitting (20), which is attached with a circular socket (21) on an open end, having a first metal ring (22) placed on the inside wall of the circular socket (21) and a metal pin (23) located at the center of the circular socket (21). The head (30) is used to house a lighting element (31) and also acts as a lamp shade. There is a plug-in portion (40) at one the end of the head (30) for insertion into the matching circular socket (21) on the open end of the terminal fitting (20). One end of the head (30) forms the plug-in portion (40) having a metal cylinder (42) mounted on the inside wall surrounding a slot, and a second metal ring (41) is mounted on the external wall.

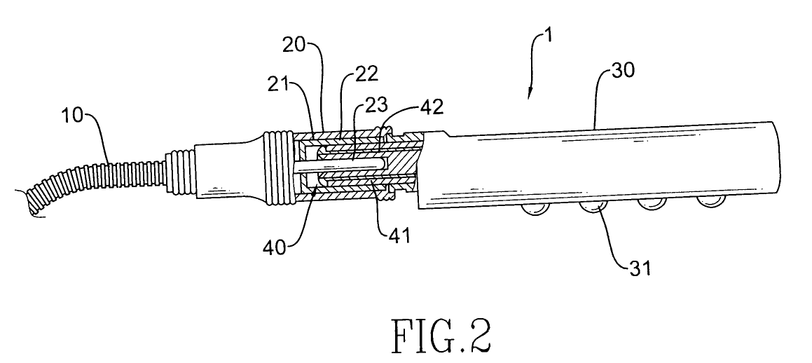

When assembling the adjustable lighting apparatus (1), as shown in FIG. 2, the plug-in portion (40) of the head (30) is fitted against the circular socket (21) attached to the open end of the terminal fitting (20) on the flexible arm (10). The positive electrode being represented by the first and second metal rings (22) (41), in contact with each other, and the negative electrode being represented by the metal cylinder (42) and the metal pin (23), in contact with each other, are connected to form an electrical circuit. When the power connector (11) is inserted into a power outlet, the lighting element (31) installed inside the head (30) is fired to emit the necessary light to a certain position from a certain projection angle.

According to the present adjustable lighting apparatus (1), the head (30) and the flexible arm (10) are constructed as separate pieces, and the head (30) is assembled onto the flexible arm (10) by joining the terminal fitting (20) of the flexible arm (10) and the plug-in portion (40) of the head (30). The contact electrodes are embedded in the terminal fitting (20) and the plug-in portion (40) to establish an electrical circuit, no matter how the head (30) is rotated. Because of this unique design, the head (30) of the adjustable lighting apparatus can be rotated around for a full circle and still be able to maintain the electrode contact for igniting the lighting element.

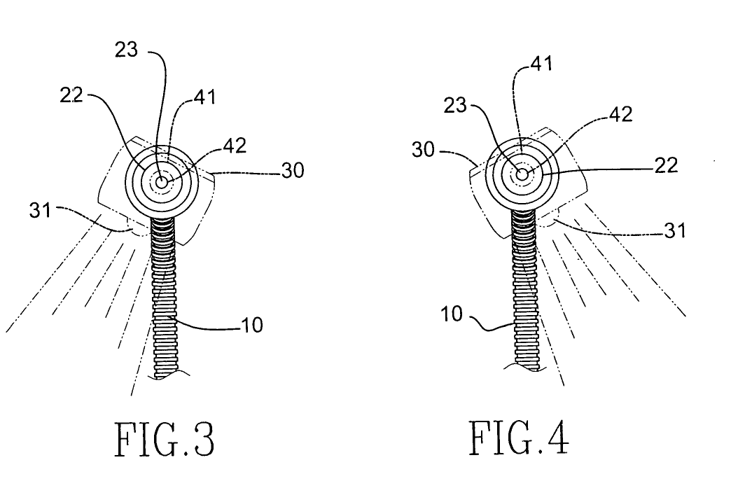

In one embodiment of the invention, the plug-in portion (40) of the head (30) is joined with the terminal fitting (20) on the flexible arm (10) such that the metal contacts on the plug-in portion (40) and the terminal fitting (20) are always in contact with the counterpart on the other section, no matter how the head (30) is rotated, as shown in FIGS. 3 and 4. With such a design, the adjustable lighting apparatus (1) can be set up with any desired light position and projection angle, avoiding the support arm from coming into the light projection path or the undesirable shifting of the lamp position as a result of the inherent elasticity of the flexible arm (10).

The foregoing description of the preferred embodiments of the present invention is intended to be illustrative only and, under no circumstances, should the scope of the present invention be so restricted.

1. An adjustable lighting apparatus having a flexible arm and a fully rotatable head, wherein
the flexible arm has a power connector on one end and a terminal fitting on another end, wherein a circular socket is attached to an open end of the terminal fitting;
the head has a lighting element installed therein and a plug-in portion at one end for insertion into the circular socket on the terminal fitting of the flexible arm.

2. The adjustable lighting apparatus as claimed in claim 1, wherein the circular socket attached to the open end of the terminal fitting has a first metal ring on inside wall of the circular socket, and a metal pin in the center,

3. The adjustable lighting apparatus as claimed in claim 1, wherein the plug-in portion of the head has a slot to accommodate a metal cylinder on inside wall of the slot, and a second metal ring on outside wall of the slot.

4. The adjustable lighting apparatus as claimed in claim 2, wherein the first and second metal rings, fully in contact with each other, representing the positive electrode, and the metal cylinder and the metal pin, also fully in contact with each other, representing the negative electrode, when joined together, are able to establish the necessary electrical contact for actuating the lighting element.

5. The adjustable lighting apparatus as claimed in claim 3, wherein the first and second metal rings, fully in contact with each other, representing the positive electrode, and the metal cylinder and the metal pin, also fully in contact with each other, representing the negative electrode, when joined together, are able to establish the necessary electrical contact for actuating the lighting element.

6. The adjustable lighting apparatus as claimed in claim 2, wherein the first and second metal rings, fully in contact with each other, representing the negative electrode, and the metal cylinder and the metal pin, also fully in contact with each other, representing the positive electrode, when joined together, are able to establish the necessary electrical contact for actuating the lighting element.

7. The adjustable lighting apparatus as claimed in claim 3, wherein the first and second metal rings, fully in contact with each other, representing the negative electrode, and the metal cylinder and the metal pin, also fully in contact with each other, representing the positive electrode, when joined together, are able to establish the necessary electrical contact for actuating the lighting element.
